(19) United States
(12) Patent Application Publication
(10) Pub. No.: US 2006/0249248 A1
(43) Pub. Date: Nov. 9, 2006

(54) Glass lens with decorated anti-splinter film

(76) Inventors: Raymond Charles Iandoli, Longwood, FL (US); Ross Alcazar, Aurora, IL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/175,945

(22) Filed: Jul. 6, 2005

Related U.S. Application Data
(60) Provisional application No. 60/678,135, filed on May 5, 2005.

(51) Int. Cl. B32B 37/00

(52) U.S. Cl. 156/256; 156/100

(57) ABSTRACT

A method of manufacturing a decorated, splinter resistant glass lens for a personal electronic device includes applying a decoration to a top surface of an anti-splinter film having an adhesive layer applied to a bottom surface. The decoration is applied to leave an open area in the decoration to allow viewing indicia therethrough. The method also includes die-cutting the decorated anti-splinter film into a film portion corresponding to a glass blank and moving the film portion onto the glass blank so that the adhesive layer contacts a surface of the glass blank. The film portion is then bonded to the surface of the glass blank to form a decorated, splinter resistant glass lens.

### SPECIFIC DATA RELATED TO THE INVENTION

This application claims the benefit of U.S. Provisional Application No. 60/678,135 filed May 5, 2005.

### FIELD OF THE INVENTION

The present invention relates to safety glass and, in particular, to a glass lens for a cell phone having a decorated anti-splinter film.

### BACKGROUND OF THE INVENTION

Electronic devices such as computer monitors, cellular and PCS telephones, Internet appliances, personal digital assistants (PDAs), home audio equipment, and kitchen appliances may include decorated glass lenses. Typically, a multi-step process performed by different machines may need to be used to produce such decorated glass lenses. Glass lenses used in such applications may need to be rendered shatter or splinter resistant for safety reasons.

### BRIEF DESCRIPTION OF THE DRAWINGS

FIG. 1 shows an exploded view of an exemplary embodiment of a glass lens with decorated anti-splinter film.

FIG. 2 shows a perspective view of an exemplary embodiment of a rolled anti-splinter film sheet.

### DETAILED DESCRIPTION OF THE INVENTION

The present invention is directed to a decorated film used as an anti-* 15 splinter feature when bonded to a glass lens. The anti-splinter film serves as both a decorative element and a safety element to prevent glass splinters and/or particles from dispersing if the glass lens is broken. Advantageously, a method of manufacturing the glass lens allows the glass lens to be produced with fewer steps than would typically be required.

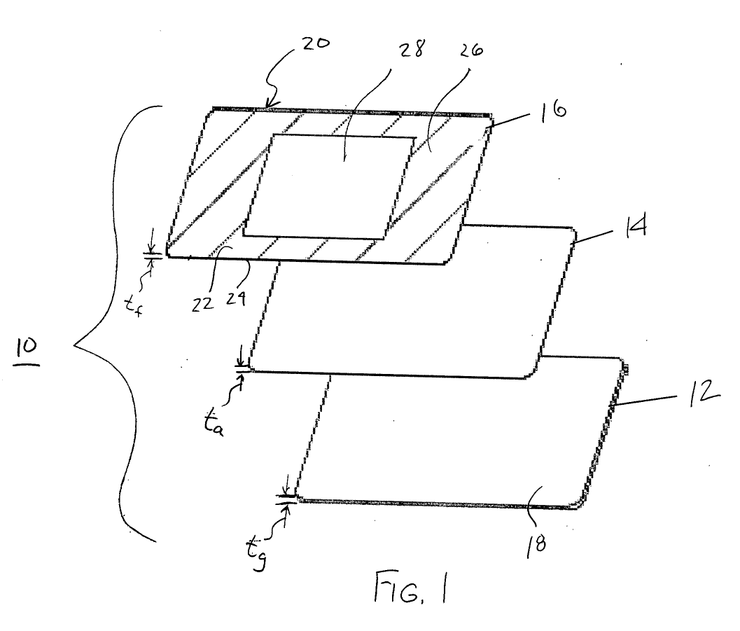

FIG. 1 shows an exploded view of an exemplary embodiment of a glass lens 10 having a decorated anti-splinter film 16. The glass lens 10 may include a glass blank 12 sized to fit a desired appliance, such as a cell phone face plate. The glass blank 12 may be formed from a silica based glass, such as float glass available from glass manufacturers such as Corning, Incorporated or Shott, Incorporated. In an aspect of the invention, the glass has a thickness t_{g} less than about 2.54 millimeters (mm), and preferably has a thickness t_{g} of between about 0.2 mm to 1.5 mm, and more preferably has a thickness t_{g} of between about 0.2 mm to 1.0 mm. An adhesive layer 14 bonds the decorated anti-splinter film 16 to the surface 18 of the glass blank 12. The adhesive layer 14 includes an optically clear adhesive having a thickness ta of between about 0.0051 mm and 0.254 mm and preferably having a thickness ta of between about 0.0127 mm and 0.127 mm. An adhesive used in the adhesive layer 14 may include an acrylic based, polymer based, and/or an ultraviolet (UV) bondable material. Suitable adhesives may include optically clear adhesives, acrylic based, or polymer based and are available from companies such as 3M, Nitto Denko, Mactac, or Adhesive Research.

The anti-splinter film 16 bonded to the surface 18 of the glass blank 12 by the adhesive layer 14 may include an optically clear plastic having a thickness t_{f} of between about 0.0051 mm and 0.508 mm, and preferably between about 0.0508 mm and 0.127 mm. The anti-splinter film 16 may include a polycarbonate, a polyethylene terephthalate (PET), polyester, transflective, and/or an acrylic material, and may include multiple layers of film. Suitable films may include OQ1030 Lexan®, available from General Electric Corporation, Mylar® or Melinex®, available from DuPont Corporation, or similar products such as polyester films available from Mitsubishi, SKC, or transflective films available from 3M.

In an aspect of the invention, the anti-splinter film 16 may be decorated before being adhered to the glass blank 12. The film 16 may decorated on an upper surface 22 or a lower surface 24. A decoration 26 may be applied using vacuum metallization techniques such as sputtering, electron beam or evaporation. In another embodiment, the decoration 26 may be applied using a printing technique such as a gravure process, offset lithography, tampo printing, and/or digital printing. In a cell phone lens application, the decoration 26 may include desired indicia applied around a perimeter 20 of the film 16 leaving sufficient room in a central portion 28 of the film 16 to allow a cell phone display to be viewed through the central portion 28 of the film 16.

A manufacturing process for producing the glass lens 10 with the decorated anti-splinter film 16 may include applying a decoration 26 to at least one surface of the anti-splinter film 16 using, for example, a vacuum metallization or printing technique. The decorated anti-splinter film 16 is than bonded to the glass blank 12 with an adhesive to form the glass lens 10. The adhesive may be applied to the lower surface 24 of the anti-splinter film 16, the surface 18 of the glass blank 12, or both surfaces 18, 24.

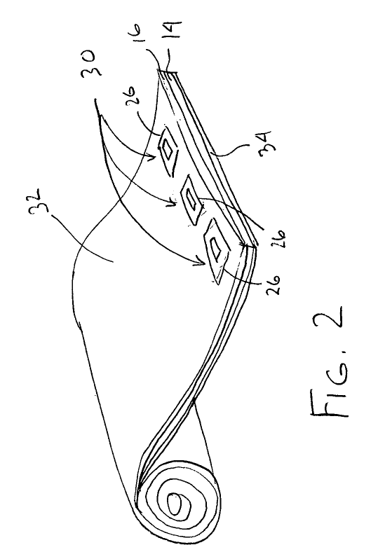

In an embodiment of the invention depicted in FIG. 2, the anti-splinter film 16 may be provided in a rolled sheet 32 and the decoration 26 applied to respective portions 30 of the sheet 32 corresponding, for example, to a desired glass blank size. Each of the decorated portions 30 of the sheet 32 may then be die cut and adhered to a respective glass blank 12 using an adhesive. In an aspect of the invention, the rolled sheet 32 may be provided with an adhesive layer 14 pre-applied to one of the surfaces of the sheet 32, and may include a release film 34 applied over the adhesive layer 14. Respective decorations 26 may be applied to a surface of the sheet opposite to the adhesive layer 14. The respective decorated portions 30 may then be die cut, so that the cut extends through the decorated anti-splinter film 16 and adhesive layer 14, but not the release film 34. Each of the die cut portions 30 may then be removed from the release film 34 and applied, adhesive side down, to a correspondingly sized glass blank.

Although several embodiments of the present invention and its advantages have been described in detail, it should be understood that mutations, changes, substitutions, transformations, modifications, variations, and alterations can be made therein without departing from the teachings of the present invention, the spirit and scope of the invention being set forth by the appended claims.

What is claimed is:

1. A method of manufacturing a decorated, splinter resistant glass lens for a personal electronic device comprising:
applying a decoration to a top surface of an anti-splinter film having an adhesive layer applied to a bottom surface;
leaving an open area in the decoration to allow viewing indicia therethrough;
die-cutting the decorated anti-splinter film into a film portion corresponding to a glass blank;
moving the film portion onto the glass blank so that the adhesive layer contacts a surface of the glass blank; and
bonding the film portion to the surface of the glass blank to form a decorated, splinter resistant glass lens.

2. The method of claim 1, wherein the anti-splinter film is supplied in a roll form.

3. The method of claim 2, wherein the anti-splinter film comprises a release film applied over the adhesive layer.

4. The method of claim 3, wherein die-cutting further comprises cutting through the anti-splinter film and leaving the release film intact.

5. The method of claim 1, wherein applying the decoration comprises vacuum metallizing the decoration onto the film or printing the decoration onto the film.

6. The method of claim 6, wherein printing the decoration comprises a gravure process, an offset lithography process, a tampo printing process, a screen printing process, or a digital printing process.

7. The method of claim 1, wherein the anti-splinter film has a thickness between about 0.0051 millimeters and 0.508 millimeters.

8. The method of claim 1, wherein the anti-splinter film has a thickness between about 0.0508 millimeters and 0.127 millimeters.

9. The method of claim 1, wherein the anti-splinter film comprises a polycarbonate, a polyethylene terephthalate, a polyester, a transflective film, or an acrylic.

10. The method of claim 1, wherein the glass blank has a thickness less than about 2.54 millimeters.

11. The method of claim 1, wherein the glass blank has a thickness between about 0.2 millimeters to 1.5 millimeters.

12. The method of claim 1, wherein the glass blank comprises a thickness between about 0.2 millimeters to 1.0 millimeters.

13. The method of claim 1, wherein the adhesive layer 14 has a thickness between about 0.0051 millimeters and 0.254 millimeters.

14. The method of claim 1, wherein the adhesive layer has a thickness between about 0.0127 millimeters and 0.127 millimeters.

15. A decorated, splinter resistant glass lens produced using the method of claim 1.
